(19) United States
(12) Patent Application Publication
(10) Pub. No.: US 2009/0112654 A1
(43) Pub. Date: Apr. 30, 2009

(54) Continuous quality assurance in a business rule management system

(75) Inventor: Michael D. Neale, Paddington (AU)

Correspondence Address: RED HAT/BSTZ;BLAKELY SOKOLOFF TAYLOR & ZAFMAN LLP, 1279 OAKMEAD PARKWAY, SUNNYVALE, CA, 94085-4040, US

(73) Assignee: Red Hat, Inc.

(21) Appl. No.: 11/978,861

(22) Filed: Oct. 29, 2007

(51) Int. Cl. G06Q 10/00; G06F 17/30; G06F 17/40

(52) U.S. Cl. 705/7

(57) ABSTRACT

Some embodiments of continuous quality assurance in a business rule management system have been presented. In one embodiment, a set of rules is maintained in a rule repository of a business rule management system (BRMS). A continuous quality assurance process is provided in the BRMS to automatically execute a predefined test on the rules in response to a change in the rules.

### TECHNICAL FIELD

Embodiments of the present invention relate to business rule management, and more specifically to quality assurance in business rule management.

### BACKGROUND

In general, a rule is a logical construct for describing the operations, definitions, conditions, and/or constraints that apply to some predetermined data to achieve a goal. Conventionally, business languages and business software (e.g., spreadsheets) may be expressed in terms of business rules. For example, in an application that determines mortgage qualification of an applicant, an age requirement may be expressed in a rule requiring the age of an applicant to be over eighteen.

Conventionally, a business rule management system (BRMS) broadly refers to a system that manages business rules. Users may compose and input business rules to a BRMS, which may store and process the business rules. For example, one exciting BRMS evaluates rules against data to determine if the conditions of any of the rules are satisfied. If the conditions of a rule are satisfied by the data, then there is a match, and the rule may be executed. As a result of the execution, consequence specified in the rule may be realized. Unlike conventional business software, business rules are generally easier to compose, and hence, business people, other than software developers, may compose and submit rules to the BRMS.

To ensure the rules from the users are free from logic and/or syntax errors, many conventional BRMSs rely on quality assurance personnel to capture a version or a snapshot of the rules at a particular time and then to manually go through the rules. Such a quality assurance (QA) approach suffers from many problems. One problem is that this process is long and tedious, and thus, is not highly reliable. Another problem is that additional changes to the rules may be submitted after a snapshot of the rules has been captured, and thus, these additional changes may not be tested until the next snapshot is captured. As a result of this loophole, the rules may be invalid, causing application errors in the application that consume the rules if there is an error in these additional changes.

### DESCRIPTION OF THE DRAWINGS

The present invention is illustrated by way of example, and not by way of limitation, in the figures of the accompanying drawings and in which:

FIG. 1 illustrates one embodiment of a process to conduct continuous quality assurance in a business rule management system.

FIG. 2 illustrates a functional block diagram of one embodiment of an application server.

FIG. 3 illustrates one embodiment of a system in which embodiments of the present invention may be implemented.

FIG. 4 illustrates a block diagram of an exemplary computer system.

### DETAILED DESCRIPTION

Described herein are some embodiments of continuous quality assurance in a business rule management system (BRMS). As discussed above, a BRMS broadly refers to a system that manages business rules. For instance, some embodiments of the BRMS may store rules, evaluate rules, and execute rules based on results of rule evaluation. In some embodiments, a set of rules is maintained in a rule repository of a BRMS. A continuous quality assurance process is provided in the BRMS to automatically execute a predefined test on the rules in response to a change in the rules.

In the following description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

Some portions of the detailed descriptions below are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general-purpose computer selectively activated or reconfigured by a computer program stored in the computer. Such a computer program may be stored in a machine-readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

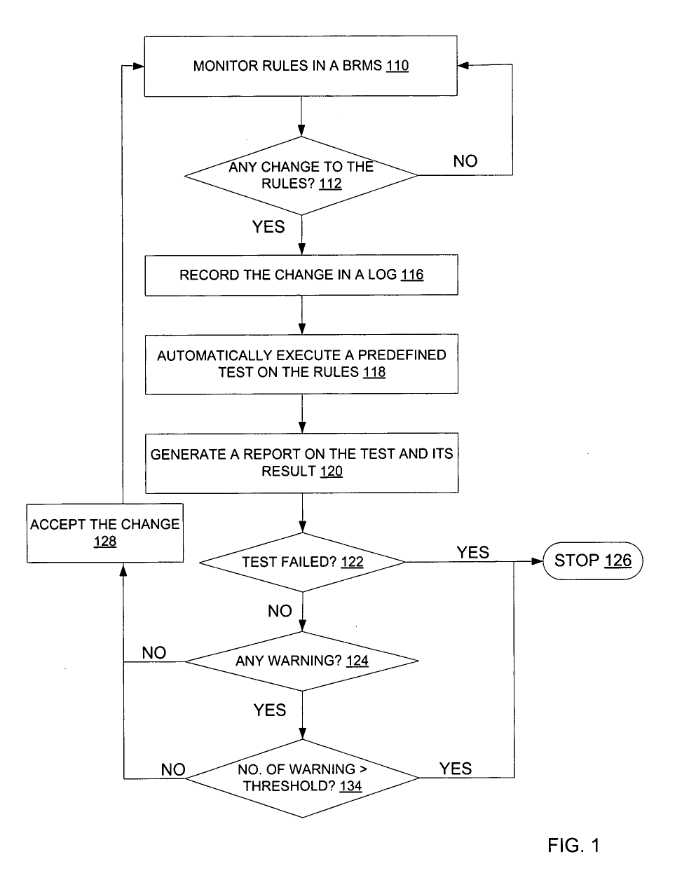

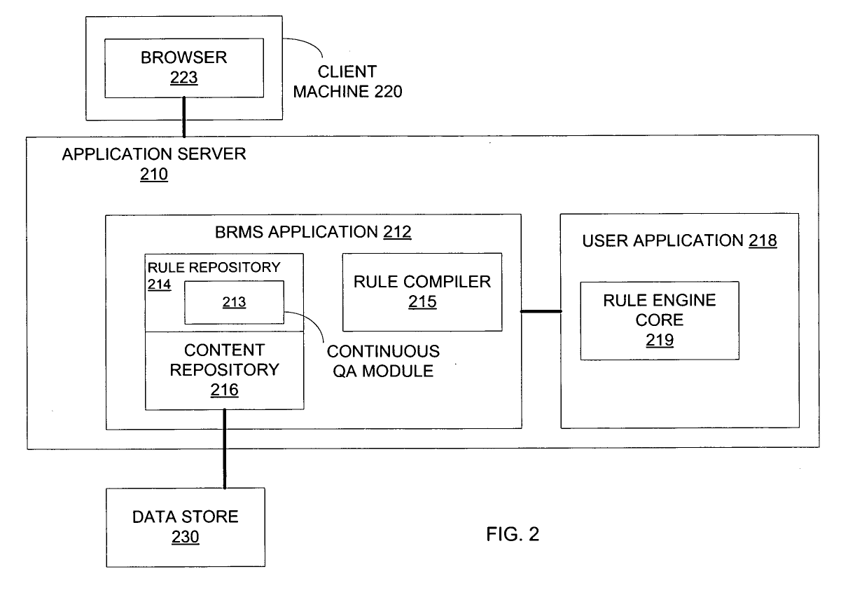

FIG. 1 illustrates one embodiment of a process to conduct continuous quality assurance (QA) in a BRMS. The process may be performed by processing logic that may comprise hardware (e.g., circuitry, dedicated logic, programmable logic, microcode, etc.), software (such as instructions run on a processing device), firmware, or a combination thereof. For example, the application server 210 shown in FIG. 2 may perform at least part of the process.

Processing logic monitors rules in the BRMS (processing block 110). In some embodiments, the rules are stored in a rule repository within the BRMS. Users of the BRMS may change the rules by adding a new rule, modifying an existing rule, and/or deleting an existing rule. Processing logic checks to determine if there is any change to the rules (processing block 112). If there is no change to the rules, then processing logic returns to processing block 110 to continue monitoring the rules. Otherwise, processing logic transitions to processing block 116 to conduct QA operations on the changed rules as described below.

If there is a change to the rules, then processing logic records the change in a log (processing block 116). The log may be used later for tracking purpose. For example, processing logic may use the record in the log to track the type of changes made to the rules, the users who have changed the rules, etc. Then processing logic automatically executes a predefined test on the changed rules (processing block 118). The predefined test may include logical analysis and/or formal analysis of the rules. Logical analysis generally checks the logic of the rules. In contrast, formal analysis generally checks the form of the rules, such as syntax of the rules. In some embodiments, there are more than one predefined tests, which may be stored in a test repository, and processing logic may execute all or some of the predefined tests. After executing the predefined test, processing logic generates a report on the test and its result (processing block 120).

Based on the result of the predefined test, processing logic checks to determine if the test has failed (processing block 122). If the test has failed, the process stops (processing block 126). Otherwise, processing logic further checks to determine if there is any warning in the result of the test (processing block 124). If there is no warning, then processing logic accepts the change to the rules (processing block 128) and then transitions back to processing block 110 to continue monitoring the rules in the BRMS. Otherwise, if there are warnings in the result of the test, then processing logic checks to determine if the number of warnings has exceeded a predetermined threshold (processing block 134). If the number of warning has exceeded the predetermined threshold, the process stops (processing block 126). Otherwise, processing logic accepts the change to the rules (processing block 128) and then transitions back to processing block 110 to continue monitoring the rules in the BRMS.

After stopping the process at processing block 126, processing logic may reject the change made to the rules and/or revert the rules to their previous version. In some embodiments, processing logic alerts users of the BRMS that the process has stopped because the predefined test has failed and/or the number of warnings exceeds the predetermined threshold. For instance, processing logic may generate or create a user interface (e.g., a graphical user interface, a command line interface, etc.) to present the alert to the users.

Using the above approach, processing logic may substantially continuously monitor the rules in the BRMS such that whenever there is a change in the rules, processing logic may test the rules to ensure the rules as changed are still free of errors. As such, processing logic may integrate a continuous QA process within the BRMS. In some embodiments, processing logic runs the above process in the background to automatically run the predefined test in response to changes in the rules, and users of the BRMS do not have to initiate testing of changes made to the rules. Furthermore, the above approach allows a consistent set of tests to be applied on the rules without intervention by the users.

Alternatively, processing logic may allow users to configure the continuous QA process. For instance, processing logic may create a user interface to allow users to modify some aspects of the continuous QA process, such as adding some predetermined tests for particular types of rules, adjusting the threshold of warnings for certain types of rules, etc.

FIG. 2 illustrates a functional block diagram of one embodiment of an application server. The application server 210 executes a BRMS application 212 and a user application 218. The application server 210 is further coupled to a client machine 220, on which a network access application (e.g., a browser 223) is executed. The BRMS application 212 includes a rule repository 214, a content repository 216, and a rule compiler 215. The user application 218 is operatively coupled to the BRMS application 212, and the user application 218 may include a rule engine core 219.

In some embodiments, rules composed by users are stored in the rule repository 214 and the rule compiler 215 may compile some or all of the rules in the rule repository 214 in response to requests from the user application 218. The rule compiler 215 provides the compiled rules to the rule engine core 219 in the user application 218 and the rule engine core 219 may evaluate the compiled rules against facts or data asserted in a working memory of the rule engine core 219. In some embodiments, the facts or data may have been retrieved from the content repository 216. The content repository 216 is a database for storing one or more types of contents, such as spreadsheet, images, records, etc. For example, the content repository 216 may include a Java content repository (e.g., Jackrabbit) to store content. Rules that result in a match against the facts or data asserted are activated. Activated rules may be fired or executed in order and/or according to their priorities as determined using a conflict resolution scheme.

Note that the rules in the rule repository 214 may be changed from time to time. For instance, users of the BRMS application 212 may add one or more new rules, delete one or more existing rules, or modify one or more existing rules in the rule repository 214. Thus, the rule repository 214 further includes a continuous quality assurance (QA) module 213 to monitor for changes in the rules and to test the rules in response to a change in the rules to ensure the modified rule are still good. To test the rules, the continuous QA module 213 may run one or more predefined tests on the rules in the rule repository 214. The predefined tests may be received from one or more users and are stored in a data store 230 operatively coupled to the application server 210. Further, the predefined tests may include tests on the logic of the rules and/or tests on the form (e.g., syntax) of the rules.

Based on results of the predefined tests, the continuous QA module 213 may accept the changes made to the rules or reject the changes. In some embodiments, the continuous QA module 213 may track the changes made to the rules in a log and generate a report periodically or on demand. The report may include information on the changes made, the users who have submitted the changes, and/or results of the predefined tests on the changed rules. The report may be sent to a system administrator and/or the user who has requested it. In some embodiments, the continuous QA module 213 may generate or create a user interface, such as a graphical user interface, to be displayed on the browser 223 for reporting the result of the predefined tests.

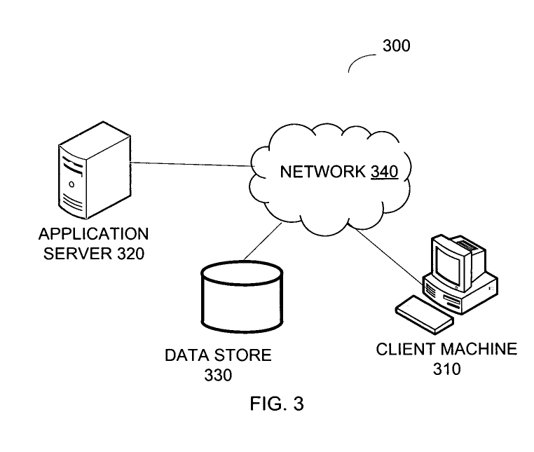

FIG. 3 illustrates one embodiment of a system in which embodiments of the present invention may be implemented. The system 300 includes a client machine 310, an application server 320, a data store 330, and a network 340. The client machine 310, the application server 320, and the data store 330 are communicatively coupled to each other via the network 340. Furthermore, the network 340 may include different types of network, such as local area network (LAN), wide area network (WAN), etc. The application server 320 implements a BRMS integrated with continuous QA, such as the application server 210 shown in FIG. 2.

In some embodiments, a user may submit a change to the rules in a rule repository of the BRMS on the application server 320 via the client machine 310. The BRMS implemented on the application server 320 has a continuous QA process integrated within, which automatically executes one or more predefined tests on the changed rules in response to the change. If the tests pass, then the change is accepted. Otherwise, if one or more of the tests fail, the change is rejected. In some embodiments, the tests may pass with one or more warning, and depending on whether the number of warning exceeds a predetermined threshold, the change may or may not be rejected. The continuous QA process further records information on the changes made and the corresponding test results to generate reports on the changes, which may be sent to the administrator and/or the user from time to time or on demand. The administrator and/or the user may access the report via a network access application (e.g., a browser, an electronic mail engine, a special-purpose reporting user interface, etc.) the client machine 310. The information tracked in the report is useful for debugging and/or evaluating the rules.

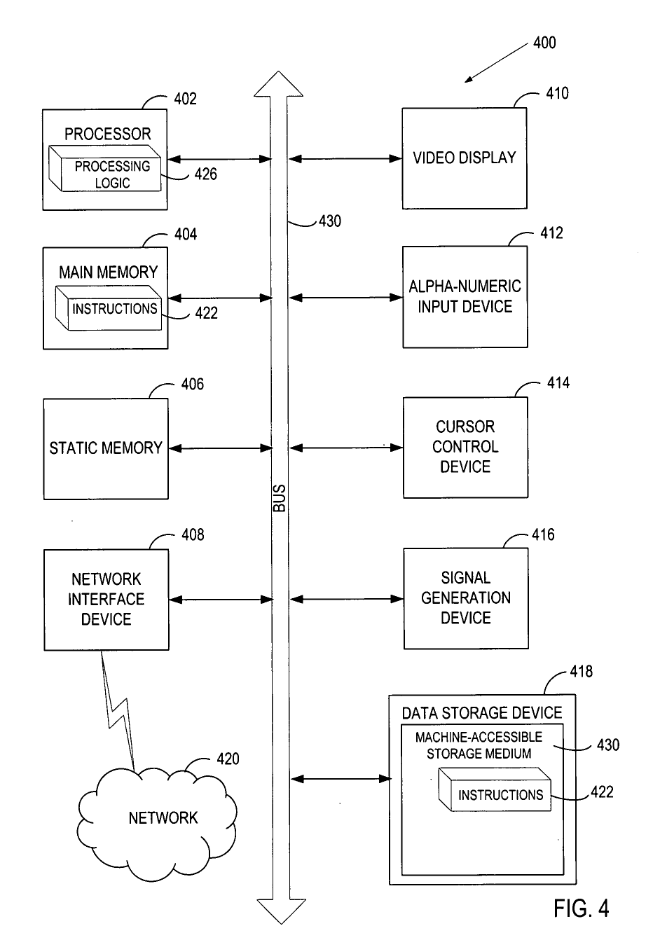

FIG. 4 illustrates a diagrammatic representation of a machine in the exemplary form of a computer system 400 within which a set of instructions, for causing the machine to perform any one or more of the methodologies discussed herein, may be executed. In alternative embodiments, the machine may be connected (e.g., networked) to other machines in a LAN, an intranet, an extranet, and/or the Internet. The machine may operate in the capacity of a server or a client machine in client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 400 includes a processing device 402, a main memory 404 (e.g., read-only memory (ROM), flash memory, dynamic random access memory (DRAM) such as synchronous DRAM (SDRAM) or Rambus DRAM (RDRAM), etc.), a static memory 406 (e.g., flash memory, static random access memory (SRAM), etc.), and a data storage device 418, which communicate with each other via a bus 430.

Processing device 402 represents one or more general-purpose processing devices such as a microprocessor, a central processing unit, or the like. More particularly, the processing device may be complex instruction set computing (CISC) microprocessor, reduced instruction set computing (RISC) microprocessor, very long instruction word (VLIW) microprocessor, or processor implementing other instruction sets, or processors implementing a combination of instruction sets. Processing device 402 may also be one or more special-purpose processing devices such as an application specific integrated circuit (ASIC), a field programmable gate array (FPGA), a digital signal processor (DSP), network processor, or the like. The processing device 402 is configured to execute the processing logic 426 for performing the operations and steps discussed herein.

The computer system 400 may further include a network interface device 408. The computer system 400 also may include a video display unit 410 (e.g., a liquid crystal display (LCD) or a cathode ray tube (CRT)), an alphanumeric input device 412 (e.g., a keyboard), a cursor control device 414 (e.g., a mouse), and a signal generation device 416 (e.g., a speaker).

The data storage device 418 may include a machine-accessible storage medium 430 (also known as a machine-readable storage medium) on which is stored one or more sets of instructions (e.g., software 422) embodying any one or more of the methodologies or functions described herein. The software 422 may also reside, completely or at least partially, within the main memory 404 and/or within the processing device 402 during execution thereof by the computer system 400, the main memory 404 and the processing device 402 also constituting machine-accessible storage media. The software 422 may further be transmitted or received over a network 420 via the network interface device 408.

While the machine-accessible storage medium 430 is shown in an exemplary embodiment to be a single medium, the term “machine-accessible storage medium” should be taken to include a single medium or multiple media (e.g., a centralized or distributed database, and/or associated caches and servers) that store the one or more sets of instructions. The term “machine-accessible storage medium” shall also be taken to include any medium that is capable of storing, encoding or carrying a set of instructions for execution by the machine and that cause the machine to perform any one or more of the methodologies of the present invention. The term “machine-accessible storage medium” shall accordingly be taken to include, but not be limited to, solid-state memories, optical and magnetic media, etc.

Thus, some embodiments of a method and an apparatus to integrate continuous QA within a BRMS have been described. It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A computer-implemented method comprising:
maintaining a plurality of rules in a rule repository of a business rule management system; and
providing a continuous quality assurance process in the business rule management system, wherein the continuous quality assurance process comprises automatically executing a predefined test on the plurality of rules in response to a change in the plurality of rules in the rule repository.

2. The method of claim 1, further comprising:
storing the predefined test in a test repository; and
repeating the test on the rules in response to a second change in the rules.

3. The method of claim 1, wherein the continuous quality assurance process comprises:
monitoring the business rule management system for changes to the plurality of rules in the rule repository.

4. The method of claim 1, further comprising:
generating a report after executing the predefined test, said report comprising information on the change in the plurality of rules, one or more users who have submitted the change to the business rule management system, and a result of the predefined test on the plurality of rules changed; and
terminating the continuous quality assurance process if the predefined test fails.

5. The method of claim 1, wherein the predefined test includes logical analysis of the plurality of rules changed.

6. The method of claim 1, wherein the predefined test includes formal analysis of the plurality of rules changed.

7. The method of claim 1, further comprising:
generating a user interface, which is accessible over a network, to allow a user to configure the continuous quality assurance process.

8. An apparatus comprising:
a business rule management system (BRMS) comprising
a rule repository to store a plurality of rules, and
a continuous quality assurance module coupled to the rule repository, the continuous quality assurance module to automatically execute a predefined test on the plurality of rules in response to a change in the plurality of rules in the rule repository; and
a core rule engine coupled to the BRMS, operable to access the plurality of rules in the rule repository when executing a business application.

9. The apparatus of claim 8, further comprising:
a test repository to store the predefined test.

10. The apparatus of claim 8, wherein the continuous quality assurance module is operable to generate a report after executing the predefined test, said report comprising information on the change in the plurality of rules, one or more users who have submitted the change to the business rule management system, and a result of the predefined test on the plurality of rules changed.

11. The apparatus of claim 8, wherein the predefined test includes logical analysis of the plurality of rules changed.

12. The apparatus of claim 8, wherein the predefined test includes formal analysis of the plurality of rules changed.

13. The apparatus of claim 8, further comprising:
a network interface to communicatively couple to a client machine via a network to cause the client machine to present a user interface to report a result of the test to a user.

14. A machine-readable medium that provides instructions that, when executed by a processor, will cause the processor to perform operations comprising:
maintaining a plurality of rules in a rule repository of a business rule management system; and
providing a continuous quality assurance process in the business rule management system, wherein the continuous quality assurance process comprises automatically executing a predefined test on the plurality of rules in response to a change in the plurality of rules in the rule repository.

15. The machine-readable medium of claim 14, wherein the operations further comprise:
storing the predefined test in a test repository; and
repeating the test on the rules in response to a second change in the rules.

16. The machine-readable medium of claim 14, wherein the continuous quality assurance process comprises:
monitoring the business rule management system for changes to the plurality of rules in the rule repository.

17. The machine-readable medium of claim 14, wherein the operations further comprise:
generating a report after executing the predefined test, said report comprising information on the change in the plurality of rules, one or more users who have submitted the change to the business rule management system, and a result of the predefined test on the plurality of rules changed; and
terminating the continuous quality assurance process if the predefined test fails.

18. The machine-readable medium of claim 14, wherein the predefined test includes logical analysis of the plurality of rules changed.

19. The machine-readable medium of claim 14, wherein the predefined test includes formal analysis of the plurality of rules changed.

20. The machine-readable medium of claim 14, wherein the operations further comprise:
generating a user interface, which is accessible over a network, to allow a user to configure the continuous quality assurance process.
